(19) United States
(12) Patent Application Publication
(10) Pub. No.: US 2024/0052775 A1
(43) Pub. Date: Feb. 15, 2024

(54) ROTARY PISTON ENGINE

(71) Applicant: Winkelmann Wankel GmbH, Frechen (DE)

(72) Inventor: Wolfgang Baier, Obbach (DE)

(21) Appl. No.: 18/448,131

(22) Filed: Aug. 10, 2023

(30) Foreign Application Priority Data
Aug. 12, 2022 (DE) 10 2022 120 392.1

(51) Int. Cl. F02B 55/04; F02B 53/12

(52) U.S. Cl. CPC F02B 55/04; F02B 53/12

(57) ABSTRACT

A rotary piston engine having a casing and a rotary piston rotating in the casing, wherein the casing comprises a casing wall enclosing the rotating rotary piston, in which casing wall a cavity is disposed for a cooling medium to flow through, and wherein an insertion bush for a spark plug is arranged in the casing wall through the cavity, and wherein the insertion bush is arranged in such a way as to be in direct contact with a cooling medium flowing through the cavity.

### CROSS-REFERENCE TO RELATED APPLICATIONS

This patent application claims priority to German utility patent application number 10 2022 120 392.1 filed Aug. 12, 2022 and titled “ROTARY PISTON ENGINE”. The subject matter of patent application number 10 2022 120 392.1 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the technical field of rotary piston engines operating according to the four-stroke principle of internal combustion engines, such as Wankel rotary piston engines.

### BACKGROUND

In a rotary piston engine, a triangular rotary piston rotates in a casing. The (arcuate-triangular) rotary piston consists of three flattened circular arcs and constantly contacts a double-arched casing wall while rotating. The casing includes an inlet and an outlet and one or more spark plugs, the inlet, the outlet and the spark plugs being arranged separately in such a way that the rotary piston in a predetermined position separates the respective chamber volumes with inlet, outlet and spark plugs.

Since the inlet and outlet are physically separated from the combustion chamber, the Wankel engine is very suitable for being driven by hydrogen. When hydrogen is used as a fuel, even the disadvantage of incomplete combustion due to the unfavorably shaped combustion chamber is not critical because the uncombusted fuel discharged is harmless to the environment. In the course of the conversion of drive systems in motor vehicles away from fossil fuels, the use of hydrogen as a fuel is increasingly attracting interest.

It is problematic with rotary piston engines that the power stroke always takes place at the same point, for which reason a steady-state temperature distribution with spatially and temporally steady-state hot and cold zones is created. A particularly high load results from the fact that ignition takes place with every rotation, which results in a high ignition sequence with a correspondingly high thermal load compared to a reciprocating four-stroke engine.

The casing and rotary piston are usually cooled by a coolant. DE 2364625 A describes a liquid-cooled casing for a rotary piston engine in which the spark plugs are arranged in succession in a coolant channel. The coolant channel runs between the spark plugs to appropriately dissipate the heat generated in the area of the spark plugs. The spark plugs are screwed into the casing in separate bush-shaped inserts.

Inserts in the casing in the area of the spark plug are also known from DE 1576205. The inserts shown here are provided with a channel which separates a pre-chamber, in which the spark plug is located, from the combustion chamber. The channel serves as an inlet channel for a fluid ignited by the spark plug, whereby improved combustion is to be realized. Such an inlet channel is also described in DE 2204560.

DE 2158708 provides for the use of a material with high thermal conductivity in the area of the spark plugs in a rotary engine. Copper pins can project into the coolant channel to dissipate the heat directly.

The present solutions have not adequately solved the basic problem of material fatigue or wear and tear of the engine casing in the area of the spark plugs in rotary piston engines.

### SUMMARY

It is the object of the present invention to eliminate the disadvantages of the prior art and to provide a rotary piston engine with good heat dissipation into the cooling medium.

This object is attained by the invention according to the independent claim. Advantageous aspects of the invention constitute the subject-matter of the respective subclaims.

The invention encompasses a rotary piston engine having a casing and a rotary piston rotating in the casing. The casing comprises a casing wall enclosing the rotating rotary piston. A cavity for a cooling medium to flow through is arranged in the casing wall. An insertion bush for a spark plug is arranged through the cavity in the casing wall. The insertion bush is arranged to be in direct contact with a cooling medium flowing through the cavity. By having the insertion bush in direct contact with the cooling medium, heat discharge is optimized, significantly reducing material fatigue or wear and tear of the engine casing in the area of the spark plugs in rotary piston engines.

### BRIEF DESCRIPTION OF THE DRAWINGS

In the following, the invention is further explained below with reference to the examples shown in the drawing:

FIG. 1 shows a sectional view of a casing of a rotary engine according to an exemplary embodiment of the invention;

FIG. 2 shows a sectional view of the area of the spark plugs with the insertion bush for the rotary engine of FIG. 1 from the side; and

FIG. 3 shows a further view of the area of the spark plugs with the insertion bush for the rotary engine of FIG. 1 from the outside.

### DETAILED DESCRIPTION

According to an advantageous aspect, the insertion bush is made of a material with high thermal conductivity. An example of such a material is copper alloys.

Advantageously, the insertion bush has a length corresponding to the length between an inner side and an outer side of the casing wall. Thus, the insertion bush can be installed flush with the inner wall and the outer wall of the casing.

Preferably, the insertion bush has at least one circumferential projection. The circumferential projection increases the surface area in contact with the cooling medium. Several projections may be arranged in parallel in the manner of cooling fins.

Preferably, the at least one circumferential projection, in the installed state, is arranged completely in the area of the cavity. This ensures efficient heat dissipation.

Preferably, the insertion bush has a circumferential recess. The circumferential recess can be located in the end section that rests against the outer wall of the casing.

Advantageously, the recess, in the installed state, is in contact with the casing wall in such a way as to form a circumferential opening for receiving a sealing element. In this way, a closed space for an elastic sealing element can be created.

Particularly preferably, the insertion bush, at least in sections on the outer circumference, has a diameter of a size and shape to be fixed in the casing in a gas-tight manner, in particular with a press fit. For this purpose, the diameter of the insertion bush at the outer circumference may be larger than the recess in the casing.

Preferably, the insertion bush has a thread at least in sections on the outer circumference. Using the thread, the insertion bush can be screwed into the casing of the rotary engine.

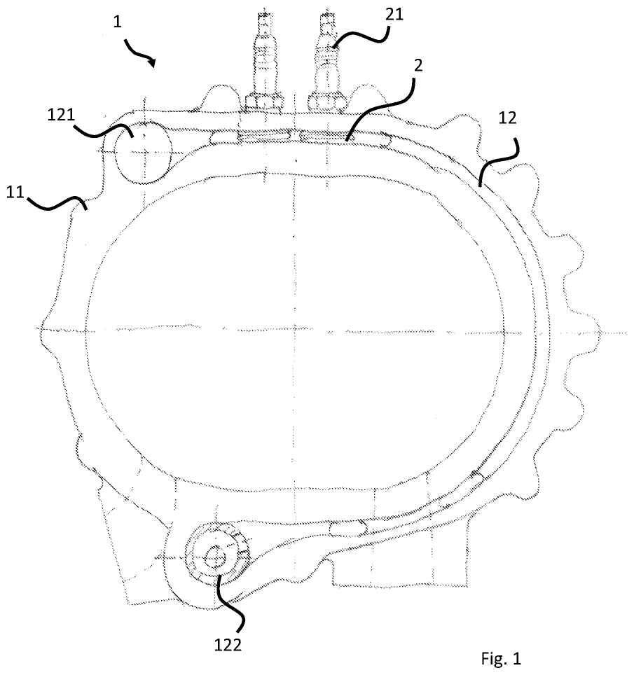

FIG. 1 shows a complete cross-section of a casing for a rotary engine according to an exemplary embodiment of the invention. The rotary piston engine comprises the casing 1 in which a rotary piston (not shown), as known for example from Wankel rotary piston engines, rotates.

The casing 1 has a casing wall 11 enclosing the rotating rotary piston. Within the casing wall 11, a cavity in the form of a cooling channel 12 for a cooling medium to flow through is disposed between a coolant inlet 122 and a coolant outlet 121. The cooling channel 12 has a predetermined width, which can be seen from FIG. 3.

An insertion bush 2 extending through the cavity 12 between the outer wall and the inner wall of the casing is arranged in the casing wall 11, into each of which a spark plug 21 is screwed.

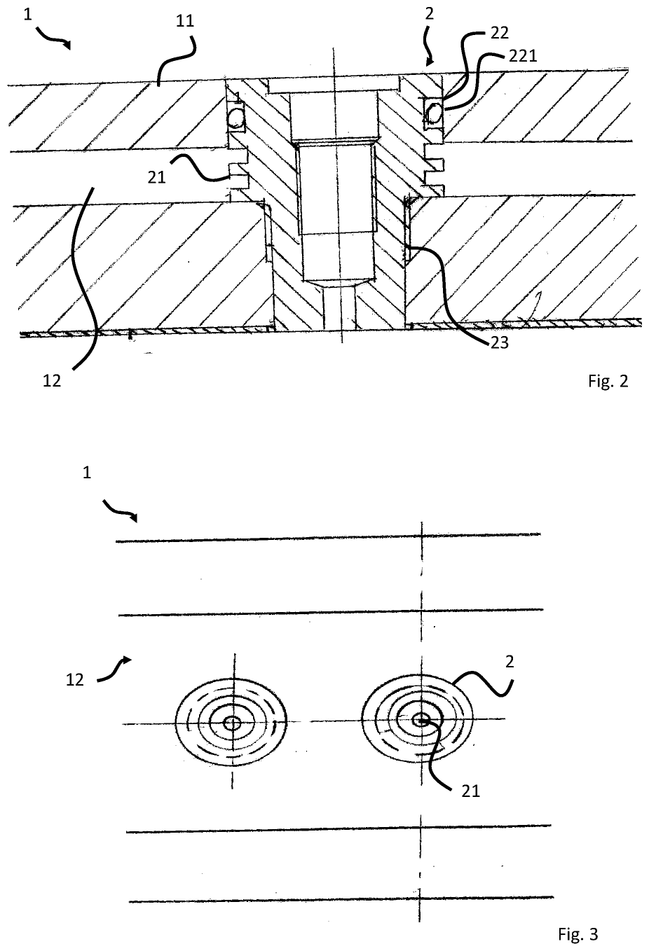

In the illustration shown, as in the sectional view in FIG. 2, the insertion bush 2 is arranged so as to come into direct contact with the cooling medium. For this purpose, the insertion bushes are screwed or pressed through the cavity 12 so that a section (located approximately in the center) is in direct contact with the cooling medium flowing through.

In the example shown, the cavity 12 forming the cooling channel is provided with a partially interrupted rib.

A section of the casing 1 is shown in FIG. 2 in a sectional view. The lateral cutout shows the area of the insertion bush 2 for receiving the spark plug (not shown).

A cavity 12 for a cooling medium to flow through is formed in the casing 1 in the manner of a cooling channel. The insertion bush 2 for a spark plug is arranged in the casing wall 11 through the cavity 12. The insertion bush 2 passes completely through the cooling channel from top to bottom, so that the insertion bush can come into contact with the cooling medium over the entire height of the cavity 12.

The insertion bush 2 is made of a copper alloy with high thermal conductivity. The insertion bush 2 has a length corresponding to the length between an inner side and an outer side of the casing wall 11.

The insertion bush 2 has a circumferential projection 21. The circumferential projection 21, in the installed state, is in the area of the cavity 12 and increases the contact surface.

In the upper end portion, the insertion bush 2 has a circumferential recess 22. In the illustrated installed state, the recess 22 is in contact with the casing wall 11 over the entire height and forms a circumferential opening for receiving a sealing element 221.

In the lower region, the insertion bush 2 is seated with a thread 23 and, for this purpose, has an outer circumference with a diameter corresponding to the opening in the casing 11 in order to achieve a gas-tight seal with respect to the ignition pressure.

FIG. 3 shows a further view of the area of the spark plugs with the insertion bushes for the rotary engine from FIG. 1 from the outside or in a horizontal section through the cavity 12. The cavity is bounded by the side parts of the casing (top/bottom).

In the casing wall 11, the cavity 12 is formed for a cooling medium to flow through in the manner of a cooling channel in the circumferential direction. The insertion bush 2 for a spark plug 21 is arranged in the casing wall 11 through the cavity 12. The insertion bush 2 passes completely through the cooling channel so that the insertion bush 2 can come into contact with the cooling medium over the entire height of the cavity 12, which is why the insertion bush 2 and spark plug 21 are shown in view in this illustration.

1. Rotary piston engine having a casing and a rotary piston rotating in the casing, wherein the casing comprises a casing wall enclosing the rotating rotary piston, in which casing wall a cavity is disposed for a cooling medium to flow through, and wherein an insertion bush for a spark plug is arranged in the casing wall through the cavity, and wherein the insertion bush is arranged in such a way as to be in direct contact with a cooling medium flowing through the cavity.

2. Rotary piston engine according to claim 1, wherein the insertion bush is made of a material with high thermal conductivity, in particular a copper alloy.

3. Rotary piston engine according to claim 1, wherein the insertion bush has a length corresponding to the length between an inner side and an outer side of the casing wall.

4. Rotary piston engine according to claim 1, wherein the insertion bush has at least one circumferential projection.

5. Rotary piston engine according to claim 4, wherein the at least one circumferential projection, in the installed state, is arranged in the area of the cavity.

6. Rotary piston engine according to claim 1, wherein the insertion bush has a circumferential recess.

7. Rotary piston engine according to claim 6, wherein the recess, in the installed state, is in contact with the casing wall in such a way as to form a circumferential opening for receiving a sealing element.

8. Rotary piston engine according to claim 1, wherein the insertion bush, at least in sections on the outer circumference, has a diameter of a size and shape to be fixed in the casing in a gas-tight manner.

9. Rotary piston engine according to claim 1, wherein the insertion bush has a thread at least in sections on the outer circumference.
